(19) United States
(12) Patent Application Publication
(10) Pub. No.: US 2009/0130408 A1
(43) Pub. Date: May 21, 2009

(54) High-strength high-clarity heat-shrinkable film

(76) Inventor: Christophe Mathe, St.Ouen du Tilleul (FR)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/919,528

(22) PCT Filed: May 2, 2006
(86) PCT No.: PCT/FR2006/000978

§ 371 Date: Mar. 3, 2008

(30) Foreign Application Priority Data
Apr. 29, 2005 (EP) 05290945.4

(51) Int. Cl. B32B 7/00

(52) U.S. Cl. 428/213

(57) ABSTRACT

The present invention relates to a high-strength high-clarity heat-shrinkable film having a yield strength of greater than 15.5 N/mm² in the machine direction and in the cross direction, comprising:
a central layer, comprising a blend of radical low-density polyethylene and of high-density polyethylene; and
two outer layers sandwiching the central layer between them, each of the outer layers comprising at least 50% by weight, relative to the total weight of the layer, of linear polyethylene and having a thickness representing from 5 to 25% of the total thickness of the film.

The present invention relates to a high-strength high-clarity heat-shrinkable film and to packaging for groups of products.

In the field of packaging for groups of products such as bottles, for example mineral water or fruit juice bottles, metal cans, for example beer or other drinks cans, and cartons, for example milk or other drinks cartons, heat-shrinkable polyethylene films are used, and more particularly heat-shrinkable polyethylene films of high clarity or not.

Heat-shrinkable polyethylene packaging films are conventionally produced by monoextrusion or coextrusion by means of an extrusion-blown film machine. The polyethylene film is extruded through an annular die and is blown to form a polyethylene bubble, which is then laid flat so as to be wound up.

The film thus obtained is then used for packaging groups of products. The film is therefore placed around the group of products to be packaged and the assembly is then placed in an oven at a temperature suitable for the film to shrink around the products of the group, so as to grip it and give it cohesion.

So-called “high-clarity” heat-shrinkable polyethylene films are obtained by coextruding three layers. More precisely, high-clarity polyethylene films comprise a central layer consisting predominantly of radical polyethylene of 0.918-0.930 relative density sandwiched between two layers of special high-gloss polyethylene consisting predominantly of linear polyethylene, obtained by metallocene synthesis (metallocene linear polyethylene), of 0.918-0.927 relative density.

In general, the glossy outer layers of high-clarity films comprise from 80 to 90% by weight, ideally 90% by weight, relative to the total weight of the blend, of metallocene linear polyethylene and the central layer comprises more than 50% by weight, relative to the total weight of the polymers, of standard radical polyethylene.

FR 2 777 502 discloses a high-clarity heat-shrinkable polyethylene film which comprises a central layer consisting of a blend of radical low-density polyethylene and of conventional linear polyethylene, and two outer layers comprising at least 50% by weight of conventional linear polyethylene, each of the two outer layers being free of metallocene linear polyethylene.

The high-clarity films used on bundling lines, namely lines for grouping bottles or various containers together; must furthermore have sufficient strength for suitable processing. A lack of strength of the film used on this type of line leads to cutting defects, when holding the film on the assembly table or during bundling. Such effects are in particular observed:
when the films are used on machines operating with a high production rate, for example 80 cycles per minute and higher;
when the thickness of the films is small, for example for films with a thickness of less than 55 μm; and/or
when the films are used in an ambient temperature above 20-25° C., and more particularly in the case of high heat, for example when the temperature reaches about 40° C.

There is therefore a need for a high-strength high-clarity film that makes it possible, apart from making it easier to process it at high rate on bundling lines and in high ambient temperature, to reduce the thickness of the packaging film and to reduce the cost of the packaging. This reduction in packaging film thickness also reduces the waste produced by intermediate and final users of the film.

The applicant has surprisingly found that, although high-density polyethylene exhibits haziness and very little gloss, to the impairment of the high-clarity film of the prior art, it is possible nevertheless to obtain a special high-strength high-clarity film having a central layer comprising radical low-density polyethylene and high-density polyethylene.

One subject of the present invention is therefore a high-strength high-clarity heat-shrinkable film having a yield strength of greater than 15.5 N/mm² in the machine direction and in the cross direction, comprising:
a central layer, comprising a blend of radical low-density polyethylene and of high-density polyethylene; and
two outer layers sandwiching the central layer between them, each of the outer layers comprising at least 50% by weight, relative to the total weight of the layer, of linear polyethylene and having a thickness representing from 5 to 25% of the total thickness of the film.

The term “high-clarity” film is understood to mean a film having a gloss of 90% or higher and a haze of 3% or less.

The gloss is measured according to the DIN 67530 Standard and the haze is measured according to the ASTM D1003 Standard.

The term “high-strength” film is therefore understood to mean a film having a yield strength of greater than 15.5 N/mm², preferably greater than 16 N/mm² and better still equal to or greater than 16.5 N/mm² in the machine direction (or longitudinal direction) and cross direction (or transverse direction) of the film. The strength is measured according to the ISO 527/3 Standard in standardized film specimens.

According to this standard, the elongation of the film is measured for an increasing tensile stress (measured in N/mm²) applied to the film at a standardized rate. The tensile curve thus obtained, representing the stress (in N/mm²) as a function of the elongation (in %), exhibits a point of inflection that characterizes the end of the elastic limit or yield point of the film. The abscissa of this point is typically between 12 and 15% elongation and the ordinate varies from one film to another, depending on the strength of the film.

The high-density polyethylene used in the central layer preferably has a relative density of between 0.945 and 0.980, better still between 0.955 and 0.965.

The relative density is itself determined by immersing the material in a liquid column having a known density gradient. The standard used is ASTM 1505.

The high-density polyethylene used in the present invention is manufactured by low-pressure gas-phase polymerization. It is characterized by a very high strength defined by the yield strength. In the present case, the yield strength of such a polymer is 30 N/mm² The high-density polyethylene is preferably present in an amount of 5 to 40% by weight and better still 10 to 20% by weight relative to the total weight of the central layer.

The radical polyethylene used in the central layer preferably has a relative density of between 0.918 and 0.935 and better still between 0.928 and 0.932. It is preferably in an amount ranging from 50 to 95% by weight and better still 80 to 90% by weight relative to the total weight of the central layer.

The central layer of the film according to the invention may furthermore include at least one additive, which is more particularly chosen from slip agents and antistatic agents. The purpose of the slip agents is to lower the coefficient of friction, in order to facilitate passage on the bundling line. The purpose of the antistatic agents is to make the surface of the film conductive, thus improving electrostatic charge dissipation. These additives may also be used in the two outer layers.

Preferably, the additive(s) is(are) in an amount ranging from 1 to 5% by weight and better still 1.5 to 2.5% by weight relative to the total weight of the central layer.

The central layer has a thickness representing from 50 to 90%, better still 70 to 90% and more particularly around 80% of the total thickness of the film. The outer layers may be of the same or different composition and with the same or different thickness, but preferably they are of the same composition and with the same thickness.

Each of the outer layers comprises at least 50% by weight, preferably 50 to 100% by weight, better still 65 to 85% by weight and more particularly 80% by weight, relative to the total weight of the layer, of linear polyethylene, the remainder being radical low-density polyethylene.

The presence in the outer layers of linear low-density polyethylene gives the film its optical properties. As regards the radical low-density polyethylene, this gives the outer layers of the film a shrinkage property, and therefore gives the film in its entirety good shrinkage.

The linear polyethylene may either be a conventional linear polyethylene having a relative density of between 0.918 and 0.936, better still between 0.925 and 0.927, or a metallocene linear polyethylene.

The metallocene linear polyethylene has a relative density of between 0.918 and 0.947 and better still between 0.918 and 0.927. The metallocene linear polyethylene preferably comprises a 1-butene, 1-hexene or 1-octene comonomer and is manufactured by gas-phase polymerization in the presence of a specific catalyst called a “metallocene” catalyst. This process makes it possible to achieve a narrow distribution of the molecular chains.

In the case in which the outer layer is free of metallocene linear polyethylene, that is to say when the linear polyethylene is a conventional linear polyethylene, the latter is preferably a linear polyethylene comprising 1-butene, 1-hexene or 1-octene, particularly 1-butene, as comonomer.

As is well known, linear polyethylenes are manufactured by gas-phase polymerization in the presence of a Ziegler-Natta catalyst.

The conventional linear polyethylene preferably has a relative density of between 0.918 and 0.936 and better still between 0.925 and 0.927.

The radical low-density polyethylene used in combination with the linear polyethylene in the outer layer is as described above and may be identical to that used in the central layer.

As is well known, the blend of polyethylenes constituting the two outer layers may include at least one additive conventionally used in the usual proportions, such as, for example, processing aids (fluoroelastomers in an amount of greater than 100 ppm, generally around 500 ppm), antistatic agents, and slip agents.

Processing aids are ingredients well known in polyethylene technology and have the purpose of making it easier to extrude linear polyethylenes and to prevent the orange peel effect by smoothing the surface of the film.

Slip agents are also conventional ingredients, the purpose of which is to lower the coefficient of friction of the film. Among these slip agents, mention may be made of erucamides.

Among antistatic agents, mention may be made of ethoxylated amines.

Each of the outer layers preferably has a thickness representing from 5 to 25%, better still 5 to 15% and more particularly around 10% of the total thickness of the film.

The films according to the invention generally have a total thickness of between 10 and 120 μm, preferably from 30 to 100 μm.

The films according to the invention are obtained by coextrusion.

Another subject of the present invention is a group of products packaged by means of a heat-shrunk film, as defined above.

The example below is intended to illustrate the present invention.

### EXAMPLE

A high-strength high-clarity heat-shrinkable polyethylene film, with a thickness of 50 μm, having the structure and the composition indicated below, was manufactured by coextrusion.

Composition in % by weight relative to the total weight of the layer:

| | Outer layer | Central | Outer layer |
|---|---|---|---|
| | 1 | layer | 2 |
| LDPE⁽¹⁾ | 20.0% | 83.4% | 20.0% |
| LLDPE⁽²⁾ | 77.0% | — | 77.0% |
| HDPE⁽³⁾ | — | 15.0% | — |
| Additives | 3.0% | 1.6% | 3.0% |
| Thickness (% of the | 10 | 80 | 10 |
| total thickness) | | | |
| Relative density of | 0.927 | 0.934 | 0.927 |
| each layer | | | |

⁽¹⁾radical low-density polyethylene of relative density d = 0.928;
⁽²⁾linear low-density polyethylene of relative density d = 0.925;
⁽³⁾high-density polyethylene, d = 0.961.

The 20° gloss of the film obtained was measured according to the DIN 67530 Standard and the haze was measured according to the ASTM D1003 Standard. The results are given below:

20° gloss: 90% haze: 3%.

The strength was evaluated by means of the yield strength, measured according to the ISO 527/3 Standard.

It was equal to 16.5 N/mm² for the above film in the machine and cross directions.

1. High-strength high-clarity heat-shrinkable film having a yield strength of greater than 15.5 N/mm² in the machine direction and in the cross direction, comprising:
a central layer, comprising a blend of radical low-density polyethylene and of high-density polyethylene; and
two outer layers sandwiching the central layer between them, each of the outer layers comprising at least 50% by weight, relative to the total weight of the layer, of linear polyethylene and having a thickness representing from 5 to 25% of the total thickness of the film.

2. Film according to claim 1, characterized in that
the high-density polyethylene has a relative density of between 0.945 and 0.980.

3. Film according to claim 1 or 2, characterized in that the high-density polyethylene is present in an amount of 5 to 40% by weight relative to the total weight of the central layer.

4. Film according to claim 3, characterized in that
the high-density polyethylene is present in an amount of 10 to 20% by weight relative to the total weight of the central layer.

5. Film according to any one of the preceding claims, characterized in that the central layer furthermore includes at least one additive chosen from slip agents and antistatic agents.

6. Film according to any one of the preceding claims, characterized in that the linear polyethylene of the outer layer is a metallocene linear polyethylene.

7. Film according to any one of claims 1 to 5, characterized in that the outer layer is free of metallocene linear polyethylene.

8. Film according to claim 7, characterized in that the linear polyethylene of the outer layer has a relative density of between 0.918 and 0.936.

9. Film according to any one of the preceding claims, characterized in that each of the outer layers comprises from 50 to 100% by weight, relative to the total weight of the layer, of linear polyethylene, the remainder being radical low-density polyethylene.

10. Film according to claim 9, characterized in that each of the outer layers comprises 80% by weight of linear polyethylene.

11. Film according to any one of claims 1 to 10, characterized in that the radical low-density polyethylene has a relative density of between 0.918 and 0.935.

12. Film according to any one of the preceding claims, characterized in that each of the outer layers has a thickness representing from 5 to 15% of the total thickness of the film.

13. Film according to claim 12, characterized in that each of the outer layers has a thickness representing 10% of the total thickness of the film.

14. Film according to any one of the preceding claims, characterized in that the total thickness of the film is between 10 and 120 μm.

15. Film according to claim 14, characterized in that the total thickness is between 30 and 100 μm.

16. Group of products packaged by means of a heat-shrunk film, characterized in that the film is as defined in any one of the preceding claims.
